(19) United States
(12) Patent Application Publication
(10) Pub. No.: US 2025/0153918 A1
(43) Pub. Date: May 15, 2025

(54) BUFFER PRODUCT FOR PACKAGING, AND INSPECTION AND MATERIAL SELECTION METHOD THEREFOR

(71) Applicant: SHANGHAI TOT TECHNOLOGY CO., LTD, Shanghai (CN)

(72) Inventor: Wenjie ZHU, Shanghai (CN)

(21) Appl. No.: 18/727,084

(22) PCT Filed: Mar. 3, 2023
(86) PCT No.: PCT/CN2023/079493

§ 371 Date: Jul. 6, 2024

(30) Foreign Application Priority Data
Jan. 7, 2022 (CN) 202220041329.2
May 23, 2022 (CN) 202210559313.5

(51) Int. Cl. B65D 81/05; B65D 65/46; B65D 81/127; G01N 3/14; G01N 3/303

(52) U.S. Cl. CPC B65D 81/053; B65D 65/466; B65D 81/127; G01N 3/14; G01N 3/303; B65D 2581/053; B65D 2581/055; G01N 2203/0003; G01N 2203/001; G01N 2203/0019; G01N 2203/0033; G01N 2203/0266

(57) ABSTRACT

The invention discloses a buffer product for packaging and an inspection and material selection method therefor. The buffer product for packaging comprises at least one base material layer and at least one buffer layer, wherein the buffer layer comprises a plurality of hollow tubes fixedly arranged on a side surface of the base material layer, and the shape of the hollow tube is a shape capable of generating elasticity. The inspection method for the buffer product for packaging comprises: a. acquiring testing data of a certain number of hollow tubes; b. performing static load-bearing calculation; c. performing dynamic load-bearing calculation; and d. assessing violent handling. In specific application, the extent of deformation and presence of damage can be used as indicators for assessing violent transportation. In addition, degradable materials may be used to realize the buffer structure for packaging provided by the invention, so as to achieve eco-friendliness.

### BACKGROUND OF THE PRESENT INVENTION

The invention relates to the technical field of packaging product testing, in particular to a buffer product for packaging, and an inspection and material selection method therefor.

### DESCRIPTION OF RELATED ARTS

The current packaging industry is divided into rigid packaging and flexible packaging. Most of the major patents for commercially producible packaging in the market are owned by European and American companies. For instance, Tetra Pak's flexible packaging, made from paper, polyethylene, and aluminum foil, accounts for 95% of the Chinese market. Rigid packaging, such as corrugated paper invented by American Albert Jones, despite its simple design, holds a large market share. Bubble wrap is also a simple yet widely used patent invented by an American.

The inventor, with over 20 years of experience in the packaging industry, has long observed the passive and low-value situation in China's packaging industry due to the lack of packaging patent technology. As a result, the inventor has been devoted to the research and development of packaging technology. However, since packaging is a consumable and environmentally sensitive product, the design must be simple, practical, and cost-effective. Balancing simplicity (like the bubble wrap patent in the US) with novelty and creativity poses a significant challenge.

To comply with the national calls for plastic bans and restrictions, carbon emission reduction, and the reduction of non-eco-friendly materials, and to elevate the position of China's packaging industry in the international market while also promoting the company's development, the inventor, after years of observation and analysis, noted that the prevalent elastic materials used in packaging are mostly plastic foam materials (like EPS plastic, EPE, PU foam, and other rubber-plastic materials). These materials exploit the elastic and soft characteristics of plastic to serve as protective packaging fillers for products. Eco-friendly materials, such as paper products, have been unable to replace plastic due to their insufficient elasticity.

Through relentless efforts and research, the inventor conducted extensive experiments and tests using eco-friendly materials such as PLA, paper, bamboo, and straw, repeatedly refining designs from basic to complex, and then from complex to simple (complex designs indeed have innovation points, but due to their high costs, they have no market potential and also waste materials, leading to over-packaging). Therefore, a novel eco-friendly buffer product and a professional testing method for the eco-friendly buffer product were designed and developed. The table below presents some test data for your review.

| | | | Testing | | | | Load- |
|---|---|---|---|---|---|---|---|
| Product | Specification/ | | pressure | | Test | | bearing test |
| name | Model (unit: mm) | Material | depth | | result | Remarks | value |
| Tube PLA | D (diameter) 5.8 | PLA (eco- | 1 | mm | 27N | | 2 mm |
| 5818502 | L (length) 185 | friendly | | | | | 40N |
| | T (thickness) 0.2 | material) | | | | | |
| Tube PLA | D (diameter) 5.8 | PLA (eco- | 2 | mm | 40N | | |
| 5818502 | L (length) 185 | friendly | | | | | |
| | T (thickness) 0.2 | material) | | | | | |
| Tube PLA | D (diameter) 5.8 | PLA (eco- | 3 | mm | 47N | | |
| 5818502 | L (length) 185 | friendly | | | | | |
| | T (thickness) 0.2 | material) | | | | | |
| Tube PLA | D (diameter) 5.8 | PLA (eco- | 4 | mm | 52N | | |
| 5818502 | L (length) 185 | friendly | | | | | |
| | T (thickness) 0.2 | material) | | | | | |
| Tube PLA | D (diameter) 5.8 | PLA (eco- | 2.5 | mm | 44N | Complete | |
| 5818502 | L (length) 185 | friendly | | | | deformation | |
| | T (thickness) 0.2 | material) | | | | | |
| Tube PLA | D (diameter) 11.5 | PLA (eco- | 3 | mm | 16N | | 5 mm |
| 11518003 | L (length) 180 | friendly | | | | | 24N |
| | T (thickness) 0.3 | material) | | | | | |
| Tube PLA | D (diameter) 11.5 | PLA (eco- | 5 | mm | 24N | | |
| 11518003 | L (length) 180 | friendly | | | | | |
| | T (thickness) 0.3 | material) | | | | | |
| Tube PLA | D (diameter) 11.5 | PLA (eco- | 8 | mm | 39N | | |
| 11518003 | L (length) 180 | friendly | | | | | |
| | T (thickness) 0.3 | material) | | | | | |
| Tube PLA | D (diameter) 11.5 | PLA (eco- | 7.5 | mm | 36N | Complete | |
| 11518003 | L (length) 180 | friendly | | | | deformation | |
| | T (thickness) 0.3 | material) | | | | | |
| Paper tube | D (diameter) 8 | Paper | 1 | mm | 0.19N | | 1 mm |
| 852006 | L (length) 52 | | | | | | 0.19N |
| | T (thickness) 0.06 | | | | | | |
| Paper tube | D (diameter) 8 | Paper | 2 | mm | 0.35N | Complete | |
| 852006 | L (length) 52 | | | | | deformation | |
| | T (thickness) 0.06 | | | | | | |
| Paper tube | D (diameter) 5.8 | Paper | 1 | mm | 70N | | 1 mm |
| 5819605 | L (length) 196 | | | | | | 70N |
| | T (thickness) 0.5 | | | | | | |
| Paper tube | D (diameter) 5.8 | Paper | 2 | mm | 77N | Complete | |
| 5819605 | L (length) 196 | | | | | deformation | |
| | T (thickness) 0.5 | | | | | | |
| Paper tube | D (diameter) 5.8 | Paper | 3 | mm | 87N | | |
| 5819605 | L (length) 196 | | | | | | |
| | T (thickness) 0.5 | | | | | | |
| Paper tube | D (diameter) 5.8 | Paper | 4 | mm | 119N | | |
| 5819605 | L (length) 196 | | | | | | |
| | T (thickness) 0.5 | | | | | | |
| Paper tube | D (diameter) 5.8 | Paper | 5 | mm | 226N | | |
| 5819605 | L (length) 196 | | | | | | |
| | T (thickness) 0.5 | | | | | | |
| Bamboo | D (diameter) 10 | Bamboo | 0.98 | mm | 139N | Complete | 0.98 mm |
| tube | L (length) 200 | | | | | deformation | 139N |
| 1020008 | T (thickness) 0.8 | | | | | | |
| Straw tube | D (diameter) 4.6 | Straw | 0.8 | mm | 16N | Complete | 0.8 mm |
| 4619703 | L (length) 197 | | | | | deformation | 16N |
| | T (thickness) 0.3 | | | | | | |

### SUMMARY OF THE PRESENT INVENTION

The invention aims to overcome the shortcomings of the prior art by providing a buffer product for packaging, and an inspection and material selection method therefor.

To achieve the above objective, a buffer product for packaging, and an inspection and material selection method therefor are provided. The buffer product for packaging comprises at least one base material layer and at least one buffer layer, the base material layer is a sheet, and the buffer layer comprises a plurality of hollow tubes fixedly arranged on a side surface of the base material layer; the hollow tube extends along its axial direction, and the axial direction of the hollow tube is parallel to the base material layer; and the shape of the hollow tube is a shape capable of generating elasticity, and a cross section of the hollow tube is a hollow circle, a hollow ellipse, a hollow sector or approximate shapes.

The invention also adopts the following preferred technical scheme.

Preferably, the product uses eco-friendly materials, such as PLA, paper, natural fiber materials and degradable materials.

Preferably, in the same buffer layer, the plurality of hollow tubes are arranged in parallel with each other, and have the same outer diameter.

Preferably, the buffer structure for packaging comprises a buffer layer, which is an integral unit, with two opposite outer planes each fixedly connected with one or more base material layers.

Preferably, the buffer structure for packaging comprises a plurality of buffer layers arranged in parallel in corresponding directions, such as vertical, horizontal, and longitudinal directions, opposite outer planes of corresponding buffer layers are each fixedly connected with one or more base material layers, and the base material layers are fixedly connected between every two adjacent buffer layers.

Preferably, on the base material layer between every two adjacent buffer layers, the connection positions of the hollow tubes of the two adjacent buffer layers with the base material layer are all in one-to-one correspondence in corresponding directions, such as vertical, horizontal, and longitudinal directions, or arranged partially correspondingly with intervals.

Preferably, the buffer structure for packaging comprises a plurality of buffer layers arranged in parallel in corresponding directions, opposite outer planes of corresponding buffer layers are fixedly connected with the base material layers respectively, and two adjacent buffer layers are fixedly connected through their hollow tubes.

Preferably, the hollow tubes of two adjacent buffer layers are all connected in a one-to-one correspondence manner in corresponding directions, or connected partially correspondingly with intervals, and spacing between two adjacent hollow tubes is smaller than a radius of the hollow tube.

Preferably, the buffer structure for packaging comprises a plurality of buffer layers arranged in parallel, and the base material layers are fixedly connected between every two adjacent buffer layers.

Preferably, an inspection and material selection method for a buffer product for packaging specifically comprises:
a. acquiring testing data of each hollow tube or a certain number of hollow tubes by means of testing equipment;
b. performing static load-bearing calculation, specifically, to match the load-bearing data of each tube or a certain number of tubes with the weight of a product to be packaged, selecting the load-bearing weight of each tube to be greater than or equal to the weight of the product;
c. performing dynamic load-bearing calculation, specifically, based on the fact that some packaged products are required to pass the drop test, that is, the packaged product undergoes free fall from a specific height, to match the load-bearing data of each tube or a certain number of hollow tubes with an impact force on the packaged product during a drop, selecting the load capacity of each tube to be greater than or equal to the force generated when the product drops; and
d. assessing violent handling, specifically, based on the fact that each tube has a limit to the force it can withstand, and exceeding the limit results in the destruction of a molecular structure of a material of the hollow tube, causing irreversible damage to it, such as breakage, indentation, deformation and so on, determining whether an external force is greater than a safe value by assessing the presence of loss and damage.

Preferably, static in the static load-bearing calculation refers to a state of being stationary or relatively motionless or studies from a static perspective, so static load refers to a force exerted by an object on a bearing object when stationary.

Preferably, dynamic in the dynamic load-bearing calculation refers to a state of ongoing change and development, or studies of states of motion and change, so dynamic load refers to load force requirements of an object in a state of motion and change within a certain range.

Preferably, in the field of packaging, during material selection, a drop test, a vibration test and/or other tests are taken as the standards, such as China drop test standards GB/T 2423.8, GB/T4857, ISO2248, ASTM, ISTA, EN71 and other self-defined standards, and finally, the appropriate packaging materials are selected based on the force exerted on the product during the drop test.

Compared with the prior art, the invention has the following advantages.

The structure is simple and feasible. In specific application of the buffer structure for packaging, the extent of deformation and presence of damage can be used as indicators for assessing violent transportation. In addition, paper, PLA, natural fiber or other degradable materials may be used to realize the buffer structure for packaging provided by the invention, so as to obtain an eco-friendly buffer product for packaging.

### BRIEF DESCRIPTION OF THE DRAWINGS

FIG. 1 is a schematic diagram of a static load-bearing calculation method according to the invention.

FIG. 2 is a schematic diagram of a dynamic load-bearing calculation method according to the invention.

FIG. 3 is a sectional view of a first buffer structure for packaging according to the invention.

FIG. 4 is a sectional view of a second buffer structure for packaging according to the invention.

FIG. 5 is a sectional view of a third buffer structure for packaging according to the invention.

FIG. 6 is a sectional view of a buffer structure for packaging according to an alternative embodiment of the invention.

FIG. 7 is a sectional view of a fourth buffer structure for packaging according to the invention.

FIG. 8 is a sectional view of a fifth buffer structure for packaging according to the invention.

Included in the drawings: 1. packaged product 2. hollow tube 10. first buffer structure for packaging 11. base material layer 12. buffer layer 12A. hollow tube X. minimum spacing between hollow tubes d. outer tube radius of hollow tube 20. second buffer structure for packaging 21. surface supporting base material layer 22. buffer layer 23. bottom supporting base material layer 30. third buffer structure for packaging 31. third upper base material layer 32. third upper buffer layer 33. intermediate base material layer 34. third lower base material buffer layer 40. buffer structure for packaging in alternative embodiment 42. upper buffer layer 43. base material layer 44. lower buffer layer 42A. upper hollow tube 44A. lower hollow tube 50. fourth buffer structure for packaging 51. fourth upper base material layer 52. fourth upper buffer layer 53. fourth lower buffer layer 54. fourth lower base material layer 60. fifth buffer structure for packaging 61. fifth upper buffer layer 62. base material layer 63. fifth lower buffer layer.

### DETAILED DESCRIPTION OF THE PREFERRED EMBODIMENT

Following the above technical scheme, specific embodiments of the invention are given below, and the invention will be further described in detail in combination with the embodiments.

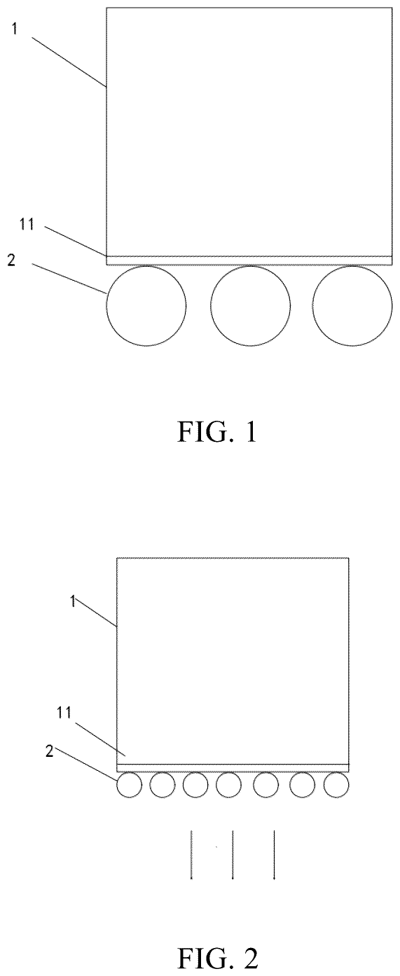

Referring to FIG. 1 which is a schematic diagram of a static load-bearing calculation method according to the invention, the load-bearing data of each hollow tube 2 or a certain number of hollow tubes 2 in the figure may match the weight of a packaged product 1, and the load-bearing weight of the hollow tubes 2 is greater than the weight of the product. For example, the pressure of a 8.262 kg packaged product 1 is 81 N, and three hollow tubes 2 are selected as the packaging material (corresponding to 27 N in Table 1). See Table 1 for other test summaries.

TABLE 1
Summary Table of Tests

| | | | | | | | Load- | |
|---|---|---|---|---|---|---|---|---|
| | Specification/ | | Testing | | | | bearing | Corresponding |
| Product | Model | | pressure | | Test | | safety test | test report |
| name | (unit: mm) | Material | depth | | result | Remarks | value | number |
| Tube PLA | Diameter 5.8 | PLA (eco- | 1 | mm | 27N | Restorable | 2 mm | UTI20211227064C-01 |
| 5818502 | Length 185 | friendly | | | | | 40N | |
| | Thickness 0.2 | material) | | | | | | |
| | | PLA (eco- | 2 | mm | 40N | Restorable | | |
| | | friendly | | | | | | |
| | | material) | | | | | | |
| | | PLA (eco- | 3 | mm | 47N | Unrestorable | | |
| | | friendly | | | | | | |
| | | material) | | | | | | |
| | | PLA (eco- | 4 | mm | 52N | Unrestorable | | |
| | | friendly | | | | | | |
| | | material) | | | | | | |
| | | PLA (eco- | 2.5 | mm | 44N | Complete | | |
| | | friendly | | | | deformation | | |
| | | material) | | | | | | |

Referring to FIG. 2 which is a schematic diagram of a dynamic load-bearing calculation method according to the invention, some packaged products 1 need to pass the drop test (the packaged product undergoes free fall from a specific height). For example, when the weight of the packaged product 1 is 1 kg, the time taken for the object to come to a complete stop upon contact with the ground is 0.01 s, the dynamic impact force is 442.72 N when the height of the free fall is 1 m, and the number of hollow tubes used is seven (corresponding to 77 N in Table 2). See Table 2 for other testing and material selection examples.

TABLE 2
Sample Table of Testing and Material Selection (Dynamic Variable)

| | | | | | | Load- | |
|---|---|---|---|---|---|---|---|
| | Specification/ | | Testing | | | bearing | |
| Product | Model | | pressure | Test | | safety | Report |
| name | (unit: mm) | Material | depth | result | Remarks | test value | number |
| Paper | Diameter 5.8 | Paper | 1 mm | 70N | Restorable | 1 mm | UTI20211227064C-02 |
| tube | Length 196 | Paper | 2 mm | 77N | Restorable | 70N | |
| 5819605 | Thickness 0.5 | Paper | 3 mm | 87N | Unrestorable | | |
| | | Paper | 4 mm | 119N | Unrestorable | | |
| | | Paper | 5 mm | 226N | Complete | | |
| | | | | | deformation | | |
| Paper | Diameter 5.8 | Paper | 1 mm | 70N | Restorable | 1 mm | UTI20211227064C-02 |
| tube | Length 196 | Paper | 2 mm | 77N | Restorable | 70N | |
| 5819605 | Thickness 0.5 | Paper | 3 mm | 87N | Unrestorable | | |
| | | Paper | 4 mm | 119N | Unrestorable | | |
| | | Paper | 5 mm | 226N | Complete | | |
| | | | | | deformation | | |

See Table 3 for the number of hollow tubes used corresponding to different heights and weights.

TABLE 3

| Free | | Duration from | Dynamic | Quantity of |
|---|---|---|---|---|
| fall height | Weight of | landing | impact | tubes used |
| (m) | object (kg) | to stop (s) | force (N) | (pieces) |
| 1 | 1 | 0.01 | 442.72 | 7 |
| 1.5 | | 0.01 | 542.22 | 8 |
| 2 | | 0.01 | 626.10 | 9 |
| 1 | 5 | 0.01 | 2213.59 | 32 |
| 1.5 | | 0.01 | 2711.09 | 39 |
| 2 | | 0.01 | 3130.50 | 45 |
| 1 | 10 | 0.01 | 4427.19 | 64 |
| 1.5 | | 0.01 | 5422.18 | 78 |
| 2 | | 0.01 | 6260.99 | 90 |
| 1 | 50 | 0.01 | 22135.94 | 317 |
| 1.5 | | 0.01 | 27110.88 | 388 |
| 2 | | 0.01 | 31304.95 | 448 |

The method to determine if an external force exceeds a safety value (violent handling) involves each hollow tube 2 having a limit to the force it can withstand. Exceeding this limit will result in the destruction of the molecular structure of the material of the hollow tube 2, causing irreversible damage to it, including breakage, indentation, deformation and so on. By assessing the presence of loss and damage, it is possible to determine whether the external force is greater than the safe value. For example, for paper tube 5819605, if the specified force is 77 N, and upon opening the package, the tube is found to be completely deformed, it indicates that a force of 226 N or higher was applied, leading to a claim. See Table 4 for other testing and material selection examples.

TABLE 4
Sample Table of Testing and Material Selection (Dynamic Variable)

| | | | | | | Load- | |
|---|---|---|---|---|---|---|---|
| | Specification/ | | Testing | | | bearing | |
| Product | Model | | pressure | Test | | safety | Report |
| name | (unit: mm) | Material | depth | result | Remarks | test value | number |
| Paper | Diameter 5.8 | Paper | 1 mm | 70N | Restorable | 1 mm | UTI20211227064C-02 |
| tube | Length 196 | Paper | 2 mm | 77N | Restorable | 70N | |
| 5819605 | Thickness 0.5 | Paper | 3 mm | 87N | Unrestorable | | |
| | | Paper | 4 mm | 119N | Unrestorable | | |
| | | Paper | 5 mm | 226N | Complete | | |
| | | | | | deformation | | |
| Paper | Diameter 5.8 | Paper | 1 mm | 70N | Restorable | 1 mm | UTI20211227064C-02 |
| tube | Length 196 | Paper | 2 mm | 77N | Restorable | 70N | |
| 5819605 | Thickness 0.5 | Paper | 3 mm | 87N | Unrestorable | | |
| | | Paper | 4 mm | 119N | Unrestorable | | |
| | | Paper | 5 mm | 226N | Complete | | |
| | | | | | deformation | | |

### Product Embodiment 1

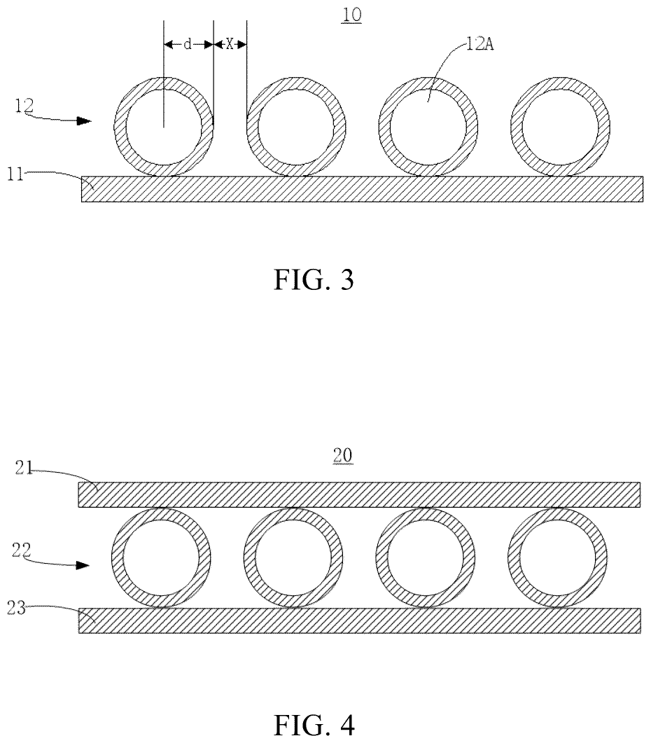

Refer to FIG. 3 which is a sectional view of a first buffer structure for packaging according to the invention. In a specific implementation scheme of the invention, a buffer structure for packaging 10 is provided, which comprises at least one base material layer 11 and at least one buffer layer 12. The base material layer 11 is a sheet, such as a support sheet. The buffer layer 12 comprises a plurality of hollow tubes 12A fixedly arranged on a side surface of the base material layer 11.

The hollow tube 12A extends along its axial direction, and the axial direction of the hollow tube 12A is parallel to a plane where the base material layer 11 is located. That is, each hollow tube 12A is arranged along the surface of the base material layer 11 in an axial extending manner.

In a preferred implementation scheme of the invention, as shown in FIG. 1, in the same buffer layer 12, the plurality of hollow tubes 12A are arranged in parallel with each other.

In a specific implementation scheme of the invention, a cross section of the hollow tube 12A is a hollow circle, a hollow ellipse, a hollow sector or approximate shapes, that is, the hollow tube 12A may be a hollow cylindrical tube or an approximate cylindrical tube, an elliptic cylindrical tube or an approximate elliptic cylindrical tube, a sector tube or an approximate sector tube, etc., among which the hollow cylindrical tube is the most ideal case. In application, adjustments can be made based on the actual situation.

In a preferred implementation scheme of the invention, in the same buffer layer 12, outer diameters of the plurality of hollow tubes 12A are the same.

The buffer structure for packaging provided by the invention is characterized in that the plurality of hollow tubes 12A are fixedly arranged on the base material layer 11 in parallel to form the buffer layer 12. When the structure is subjected to an external force, the hollow tube 12A will deform and generate resilience, thus providing a buffer for the whole packaged product and mitigating the impact of the external force on the contents. In specific application of the buffer structure for packaging, the extent of deformation and presence of damage can be used as indicators for assessing violent transportation. In addition, paper, PLA, natural fiber or other degradable materials may be used to realize the buffer structure for packaging provided by the invention, so as to obtain an eco-friendly buffer product for packaging.

In a preferred implementation scheme of the invention, in the same buffer layer 12, minimum spacing X between adjacent hollow tubes 12A is greater than zero and less than or equal to an outer tube radius d of the hollow tubes 12A.

With the buffer structure for packaging in this preferred implementation scheme, when it is subjected to an external force, the hollow tube 12A will deform to some extent; when the deformation continues and reaches a certain degree, adjacent hollow tubes 12A abut against each other, and then a supporting force is generated between them, which can resist the external force and prevent them from being crushed; and when the external force disappears, the abutting/supporting force between adjacent hollow tubes can facilitate their rebound. The inventor found through experimentation that a certain gap needs to be left between adjacent hollow tubes 12A to ensure that a certain space is provided for the deformation of the hollow tubes 12A when stressed, and the whole buffer layer is not too hard. In addition, the gap (minimum spacing) between adjacent hollow tubes 12A is less than or equal to the radius, in order to ensure that the hollow tubes 12A can abut against each other before being completely crushed, generate mutual support force, and support and resist the external force, and rebound is also facilitated, thus providing an excellent buffer for the whole packaged product.

In a preferred implementation scheme of the invention, when the hollow tubes 12A in the buffer layer 12 are made of paper, in the same buffer layer 12, minimum spacing X between adjacent hollow tubes 12A is greater than zero and less than or equal to an outer tube radius d of the hollow tubes 12A.

In another alternative implementation scheme of the invention, in the same buffer layer 12, the minimum spacing X between adjacent hollow tubes 12A may also be larger than the outer tube radius d of the hollow tubes 12A, for example, when the hollow tubes 12A in the buffer layer 12 are made of a hard material, such as PLA.

Regarding the fixing method of the hollow tube 12A and the base material layer 11, in a preferred implementation scheme of the invention, in the buffer layer 12, the hollow tube 12A is fixed on the side surface of the base material layer 11 by bonding, for example, each hollow tube 12A may be processed separately, and then bonded and fixed on the side surface of the base material layer 11 in turn. For example, it is also possible to manufacture a plurality of hollow tubes 12A directly on a sheet by creating folding lines according to predetermined dimensions, followed by inward squeezing (in practical production, there may be unsealed gaps in tube walls of the hollow tubes 12A), and then the entire assembly is bonded to the side surface of the base material layer 11.

Specifically, in this embodiment, as shown in FIG. 3, the buffer structure for packaging 10 comprises a base material layer 11 and a buffer layer 12; the buffer layer 12 comprises a plurality of hollow tubes 12A arranged in parallel and bonded and fixed on a side surface (upper surface shown in FIG. 3) of the base material layer 11; and in this buffer layer 12, outer tube diameters of the plurality of hollow tubes 12A are the same, and minimum spacing X between adjacent hollow tubes 12A is greater than zero and less than or equal to an outer tube radius d of the hollow tubes 12A.

### Product Embodiment 2

Referring to FIG. 4 which is a sectional view of a second buffer structure for packaging according to the invention, the buffer structure for packaging 20 comprises a buffer layer 22, which is an integral unit, with two opposite outer planes fixedly connected with a base material layer 21 and a base material layer 23 respectively.

That is, the base material layers 21 and 23, i.e., a surface supporting base material layer and a bottom supporting base material layer, are arranged on upper and lower planes of the buffer layer 22 respectively, so that a plurality of hollow tubes of the buffer layer 22 are protected in the middle layer, and better buffering performance can be provided.

### Product Embodiment 3

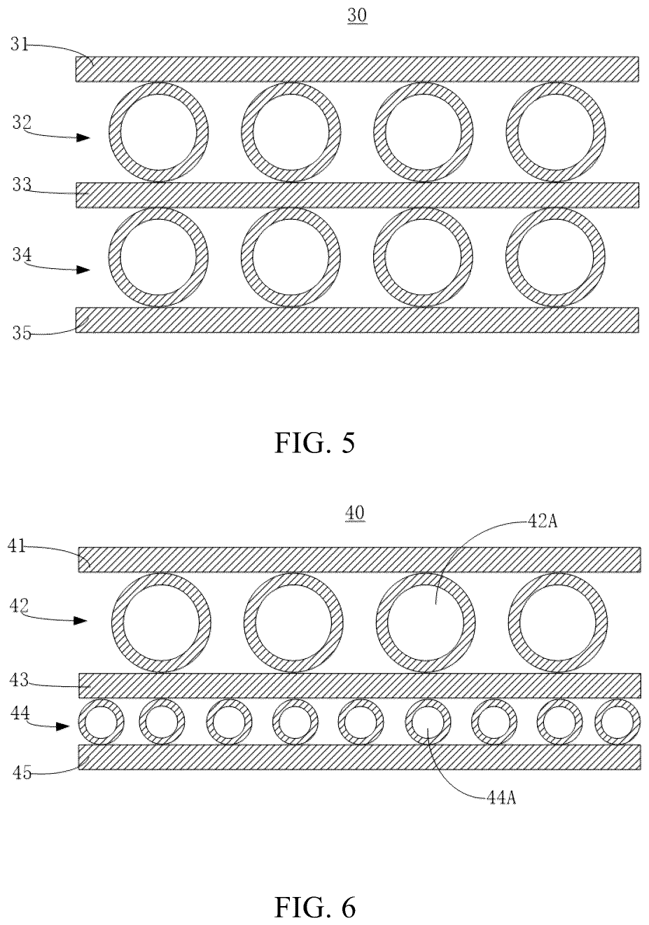

Referring to FIG. 5 which is a sectional view of a third buffer structure for packaging according to the invention, the buffer structure for packaging 30 comprises a plurality of buffer layers 32 and 34 arranged in parallel with one above another. A base material layer 31 and a base material layer 35 are fixedly connected to two opposite outer planes of the uppermost buffer layer 32 and the lowermost buffer layer 34 respectively, and a base material layer 33 is fixedly connected between every two adjacent buffer layers 32 and 34.

In other words, for the buffer structure for packaging 30 in the above preferred implementation scheme, a plurality of buffer layers 32 and 34 arranged in parallel with one above another are provided, and the upper and lower planes of each buffer layer are each fixedly connected with a base material layer.

Specifically, in this embodiment, the buffer structure for packaging 30 comprises two buffer layers 32 and 34 arranged in parallel with one above the other. A base material layer 31 and a base material layer 35 (i.e., a surface supporting base material layer and a bottom supporting base material layer) are fixedly connected to two opposite outer planes of the two buffer layers 32 and 34 respectively. An intermediate base material layer 33 is fixedly connected between the two buffer layers 32 and 34.

In a more preferred implementation scheme of the invention, on the base material layer 33 between every two adjacent buffer layers 32 and 34, the connection positions of a plurality of hollow tubes of the two adjacent buffer layers 32 and 34 with the base material layer 33 are all in one-to-one correspondence in the vertical direction. In other words, if the outer tube diameters of the plurality of hollow tubes of the two adjacent buffer layers 32 and 34 are the same, the connection positions of each hollow tube of the two adjacent buffer layers 32 and 34 with the base material layer between them are set in one-to-one correspondence in the vertical direction.

Specifically, in this embodiment, as shown in FIG. 5, the hollow tubes of the buffer layers 32 and 34 arranged in parallel with one above the other have the same outer tube diameter, and their positions, more precisely, their connection positions with the intermediate base material layer 33 are in one-to-one correspondence in the vertical direction. Such a buffer structure can better transmit the external force between the buffer layers 32 and 34 and the intermediate base material layer 33, and achieve a more balanced buffer effect.

In an alternative embodiment of this embodiment, as shown in FIG. 6, the outer tube diameters of a plurality of hollow tubes of two adjacent buffer layers 42 and 44 are different. The outer tube diameter of the buffer layer 42 is larger, and the outer tube diameter of the buffer layer 44 is smaller. In order to facilitate the transmission of the external force, the connection positions of the hollow tubes 42A of the buffer layer 42 and part of the hollow tubes 44A of the buffer layer 44 with the intermediate base material layer 43 are set correspondingly (arranged correspondingly with intervals).

### Product Embodiment 4

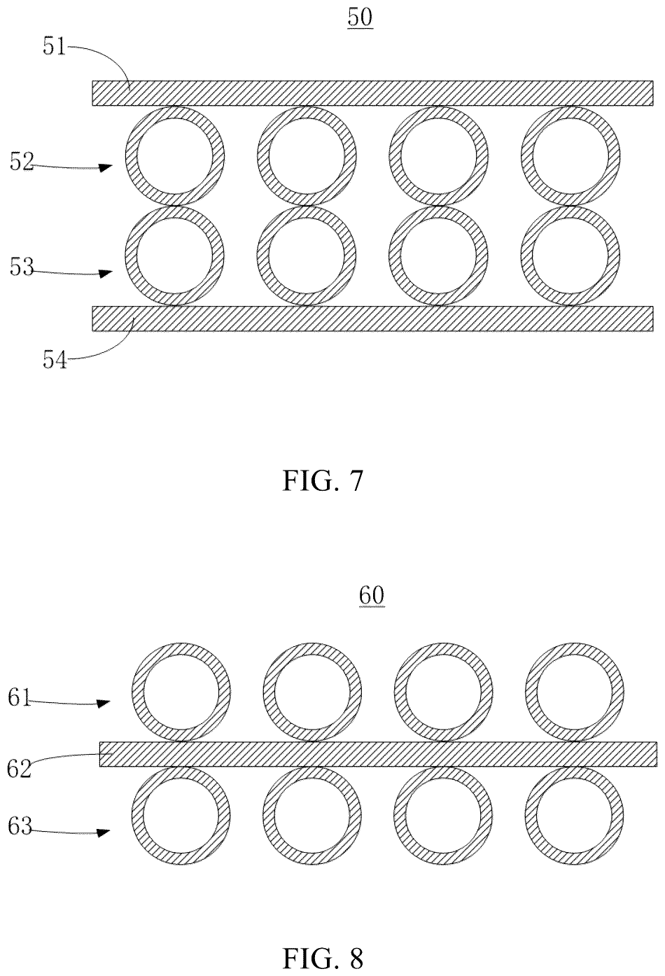

Referring to FIG. 7 which is a sectional view of a fourth buffer structure for packaging according to the invention, in a preferred implementation scheme of the invention, the buffer structure for packaging 50 comprises a plurality of buffer layers 52 and 53 arranged in parallel with one above another. A base material layer 51 and a base material layer 54 are fixedly connected to two opposite outer planes of the uppermost buffer layer 52 and the lowermost buffer layer 53 respectively, and the adjacent buffer layers 52 and 53 are fixedly connected through their hollow tubes.

Specifically, in this embodiment, as shown in FIG. 7, the buffer structure for packaging 50 comprises two buffer layers 52 and 53 arranged in parallel with one above the other. A base material layer 51 and a base material layer 54 (i.e., a surface supporting base material layer and a bottom supporting base material layer) are fixedly connected to two opposite outer planes of the two buffer layers 52 and 53 respectively. No intermediate base material layer is provided between the two buffer layers 52 and 53, but the two buffer layers 52 and 53 are fixedly connected directly.

In a more preferred implementation scheme of the invention, a plurality of hollow tubes in each buffer layer and a plurality of hollow tubes in adjacent buffer layers are all connected in a one-to-one correspondence manner in the vertical direction. In other words, the outer tube diameters of the plurality of hollow tubes in two adjacent buffer layers 52 and 53 are the same (the outer tube diameters of the plurality of hollow tubes in each buffer layer 52 are the same as those of the plurality of hollow tubes in the adjacent buffer layer 53), and all the hollow tube in two adjacent buffer layers 52 and 53 are fixedly connected in a one-to-one correspondence manner in the vertical direction.

In an alternative embodiment of this embodiment, similar to the above-mentioned example of FIG. 4, the outer tube diameters of a plurality of hollow tubes of two adjacent buffer layers are different, and in order to facilitate the transmission of the external force, all the hollow tubes of the buffer layer with a larger outer tube diameter are connected with part of the hollow tubes of the buffer layer with a smaller outer tube diameter (connected partially correspondingly with intervals).

### Product Embodiment 5

Referring to FIG. 8 which is a sectional view of a fifth buffer structure for packaging according to the invention, the buffer structure for packaging 60 comprises a plurality of buffer layers 61 and 63 arranged in parallel with one above another, and a base material layer 62 is fixedly connected between every two adjacent buffer layers 61 and 63.

Specifically, in this embodiment, the buffer structure for packaging 60 comprises two buffer layers 61 and 63 arranged in parallel with one above the other. A base material layer 62 is fixedly connected between the two buffer layers 61 and 63.

Compared with the above-mentioned Embodiment 3, the base material layers 31 and 35 (i.e., the surface supporting base material layer and the bottom supporting base material layer) fixedly connected to the upper and lower outer planes are removed. Other conditions are exactly the same as those in Embodiment 3, which will not be repeated here.

For those skilled in the art, upon learning about the buffer structure for packaging of the invention, they can then apply it to the production of packaging materials/packaging products.

For the materials of the base material layer 11 and the hollow tube 12A, paper or degradable materials such as PLA may be used. In conventional application, paper is preferred because of its lower cost compared with other degradable materials. The buffer structure of the invention is not limited to paper, and the grammage, thickness and hardness of the base material layer 11 and the hollow tube 12A may be selected and adjusted by those skilled in the art according to the materials and specific packaging application requirements after learning about the buffer structure of the invention.

The above embodiments are only preferred ones of the invention, and the protection scope of the invention is not limited thereto. Any equivalent substitution or change made by any person familiar with the technical field within the technical scope disclosed by the invention according to the technical scheme and inventive concept of the invention shall be covered within the protection scope of the invention.

1. A buffer product for packaging, comprising at least one base material layer and at least one buffer layer, wherein the base material layer is a sheet, the buffer layer comprises a plurality of hollow tubes fixedly arranged on a side surface of the base material layer, the hollow tube extends along its axial direction, the axial direction of the hollow tube is parallel to the base material layer, and the shape of the hollow tube is a shape capable of generating elasticity.

2. The buffer product for packaging according to claim 1, wherein a cross section of the hollow tube is a hollow circle, a hollow ellipse, a hollow sector or approximate shapes.

3. The buffer product for packaging according to claim 1, wherein the product uses eco-friendly materials, such as PLA, paper, natural fiber materials and degradable materials.

4. The buffer product for packaging according to claim 1, wherein in the same buffer layer, the plurality of hollow tubes are arranged in parallel with each other, and have the same outer diameter.

5. The buffer product for packaging according to claim 1, wherein the buffer structure for packaging comprises a buffer layer, which is an integral unit, with two opposite outer planes each fixedly connected with one or more base material layers.

6. The buffer product for packaging according to claim 1, wherein the buffer structure for packaging comprises a plurality of buffer layers arranged in parallel in corresponding directions, such as vertical, horizontal, and longitudinal directions, opposite outer planes of corresponding buffer layers are each fixedly connected with one or more base material layers, and the base material layers are fixedly connected between every two adjacent buffer layers.

7. The buffer product for packaging according to claim 6, wherein on the base material layer between every two adjacent buffer layers, the connection positions of the hollow tubes of the two adjacent buffer layers with the base material layer are all in one-to-one correspondence in corresponding directions, such as vertical, horizontal, and longitudinal directions, or arranged partially correspondingly with intervals.

8. The buffer product for packaging according to claim 1, wherein the buffer structure for packaging comprises a plurality of buffer layers arranged in parallel in corresponding directions, opposite outer planes of corresponding buffer layers are fixedly connected with the base material layers respectively, and two adjacent buffer layers are fixedly connected through their hollow tubes.

9. The buffer product for packaging according to claim 8, wherein the hollow tubes of two adjacent buffer layers are all connected in a one-to-one correspondence manner in corresponding directions, or connected partially correspondingly with intervals, and spacing between two adjacent hollow tubes is smaller than a radius of the hollow tube.

10. The buffer product for packaging according to claim 1, wherein the buffer structure for packaging comprises a plurality of buffer layers arranged in parallel, and the base material layers are fixedly connected between every two adjacent buffer layers.

11. (canceled)

12. An inspection and material selection method for a buffer product for packaging, comprising:
a. acquiring testing data of each hollow tube or a certain number of hollow tubes by means of testing equipment;
b. performing static load-bearing calculation, specifically, to match the load-bearing data of each hollow tube or a certain number of hollow tubes with the weight of a product to be packaged, selecting the load-bearing weight of each hollow tube to be greater than or equal to the weight of the product;
c. performing dynamic load-bearing calculation, specifically, based on the fact that some packaged products are required to pass the drop test, that is, the packaged product undergoes free fall from a specific height, to match the load-bearing data of each hollow tube or a certain number of hollow tubes with an impact force on the packaged product during a drop, selecting the load capacity of each hollow tube to be greater than or equal to the force generated when the product drops; and
d. assessing violent handling, specifically, based on the fact that each hollow tube has a limit to the force it can withstand, and exceeding the limit results in the destruction of a molecular structure of a material of the hollow tube, causing irreversible damage to it, such as breakage, indentation, deformation and so on, determining whether an external force is greater than a safe value by assessing the presence of loss and damage.

13. The inspection and material selection method for the buffer product for packaging according to claim 12, wherein static in the static load-bearing calculation refers to a state of being stationary or relatively motionless or studies from a static perspective, so static load refers to a force an object is able to endure when stationary.

14. The inspection and material selection method for the buffer product for packaging according to claim 12, wherein dynamic in the dynamic load-bearing calculation refers to a state of ongoing change and development, or studies of states of motion and change, so dynamic load refers to load force requirements of an object in a state of motion and change within a certain range.

15. The inspection and material selection method for the buffer product for packaging according to claim 14, wherein in the field of packaging, during material selection, a drop test, a vibration test and/or other tests are taken as the standards, such as China drop test standards GB/T 2423.8, GB/T4857, ISO2248, ASTM, ISTA, EN71 and other self-defined standards, and finally, the appropriate packaging materials are selected based on the force exerted on the product during the drop test.

16. The buffer product for packaging according to claim 4, wherein the buffer structure for packaging comprises a buffer layer, which is an integral unit, with two opposite outer planes each fixedly connected with one or more base material layers.

17. The buffer product for packaging according to claim 4, wherein the buffer structure for packaging comprises a plurality of buffer layers arranged in parallel in corresponding directions, such as vertical, horizontal, and longitudinal directions, opposite outer planes of corresponding buffer layers are each fixedly connected with one or more base material layers, and the base material layers are fixedly connected between every two adjacent buffer layers.

18. The buffer product for packaging according to claim 4, wherein the buffer structure for packaging comprises a plurality of buffer layers arranged in parallel in corresponding directions, opposite outer planes of corresponding buffer layers are fixedly connected with the base material layers respectively, and two adjacent buffer layers are fixedly connected through their hollow tubes.
